(19) United States
(12) Patent Application Publication
(10) Pub. No.: US 2012/0144679 A1
(43) Pub. Date: Jun. 14, 2012

(54) Hair Clipper Blade Assembly

(75) Inventor: Woo Seong Hwang, Palatine, IL (US)

(73) Assignee: KINGDOM INTERNATIONAL CO., LTD., Incheon (KR)

(21) Appl. No.: 13/396,238

(22) Filed: Feb. 14, 2012

Related U.S. Application Data
(62) Division of application No. 12/484,759, filed on Jun. 15, 2009.

(30) Foreign Application Priority Data
Jul. 7, 2008 (KR) 10-2008-0065712

(51) Int. Cl. B26B 19/38

(52) U.S. Cl. 30/224

(57) ABSTRACT

The present invention relates to an electric hair clipper blade assembly having a guide plate connected with a fixed blade and a movable blade that moves in a left and right direction or horizontal direction and a connection/fixed member. In particular, the present invention relates to an electric hair clipper blade assembly having fixed and movable blades with depths deeper than those of conventional fixed and movable blades and a blade body DLC-coated, on which a portion of the guide plate, the fixed blade, and the movable blade are formed, to maintain fairly good cutting power in cutting short hair or curly hair.

### CROSS-REFERENCE TO RELATED PATENT APPLICATIONS

This application is a divisional application of U.S. patent application Ser. No. 12/484,759, filed Jun. 15, 2009, which claims the benefit of Korean Patent Application No. 10-2008-0065712, filed Jul. 7, 2008 in the Korean Intellectual Property Office. The disclosures of these applications are incorporated herein in their entirety by reference.

### BACKGROUND

1. Field of the Invention

The present invention relates to an electric hair clipper blade assembly having a guide plate connected with a fixed blade and a movable blade that moves in left and right directions and a horizontal direction and a connection/fixed member. In particular, the present invention relates to an electric hair clipper blade assembly having fixed and movable blades with depths deeper than those of conventional fixed and movable blades and a blade body DLC-coated, on which a portion of the guide plate, the fixed blade, and the movable blade are formed, to maintain fairly good cutting power in cutting various types of hair including short hair or curly hair.

2. Description of the Related Art

Usually, a conventional electric hair clipper includes a fixed blade, a movable blade being movable in a horizontal direction to cut hairs, and a plate for supporting the fixed blade and the movable blade. The fixed blade is positioned on the front portion of the electric hair clipper and the movable blade is located on or over the fixed blade and moves in the left/right and horizontal directions by an operation of an electric motor to cut hairs.

However, in a conventional hair clipper, the fixed blade has comb teeth of a shallow depth. The comb teeth having the shallow depth provide average cutting power and it is difficult to cut short hair or curly hair to obtain a desired hair length and maintain good cutting power.

In addition, with respect to the hair clipper blades of a conventional hair clipper, abrasion of the hair clipper blades and significant noise occur due to the friction power of the movable blade and the fixed blade, which have a metal component. When diminishing an adhesive degree between the movable blade and the fixed blade for reducing the friction power, there was a problem that the hair is not normally cut.

FIG. 1 is a perspective view of a conventional hair clipper blade assembly having an oilless metal. The conventional hair clipper blade assembly is described in detail referring to FIG. 1.

First, a fixed blade 10 is fixed in a supporting bracket 15. A movable blade 20 is positioned on the fixed blade 10. Also, the movable blade 20 is fixed by an engineering plastic 25, and thereby fixed in a front portion of the engineering plastic 25 by a rotation movement of a motor not shown transmitted through an eccentric cam so as to be located on the fixed blade 10. Thereby, the movable blade 20 is adhered to the fixed blade by a coil spring 40. The oilless metal 50 is inserted into a groove portion 251 formed in a rear portion of the engineering plastic 25 and equipped with the groove portion 251, such that the movable blade 20 coupled with the front portion of the engineering plastic 25 is capable of sliding on the fixed blade 10.

The hair clipper shown in FIG. 1 is similar to a conventional hair clipper having an implantation surface formed in a middle portion of an etching blade formed on an end of the movable blade 20, an etching implantation surface is formed between the etching blades of the movable blade 20 to prevent that hairs or residuum thereof are inserted between the movable blade 20 and the fixed blade 10. However, in an embodiment of the present invention, the length of the movable blade of the hair clipper with oilless metal is minimized and the length of the movable blade manufactured by an etching process and having a thickness of 0.4 mm is 20˜30% with respect to that of the fixed blade, to have an effective cutting power without oil.

In other words, a feature of a conventional hair clipper was to include a movable blade with minimized magnitude, that is, minimized length. The oilless metal inserted into and connected with the rear-lower portion of the engineering plastic was inserted into the fixed blade with a guide formed on a top portion thereof and was slidden, and the movable blade moved in left and right directions. The foregoing construction was able to provide the hair clipper with fairly good horizontal power.

However, the construction of a conventional hair clipper needed the oilless metal and additional elements for inserting and coupling the oilless metal, thereby increasing the difficulty of manufacturing the hair clipper blade assembly. In addition, the depths of the movable blade and the fixed blade of a conventional hair clipper were not long enough and therefore, it was hard to cut certain hair styles and types of hair such as curly hair. The movable blade was able to move in the left and right directions by the oilless metal to provide a hair clipper blade with fairly good horizontal power. However, when rotating with high speed, heat occurrence and abrasion problems due to surface friction between metals still remained.

### BRIEF DESCRIPTION OF THE DRAWINGS

The features and advantages of the present invention will become apparent by describing in detail embodiments thereof with reference to the attached drawings in which:

FIG. 1 is a perspective view of a conventional hair clipper blade assembly equipped with an oilless metal;

FIG. 2 is a top view, a bottom view, and a lateral view of a fixed blade and a fixed blade body according to an embodiment of the present invention;

FIG. 3 is a top view, a bottom view, and a lateral view of a movable blade and a movable blade body according to an embodiment of the present invention;

FIG. 4 is a perspective view of a fixed blade and a fixed blade body according to an embodiment of the present invention;

FIG. 5 is a perspective view of a movable blade and a movable blade body according to an embodiment of the present invention;

FIG. 6 shows a guide plate and a fixed plate according to an embodiment of the present invention;

FIG. 7 is a perspective view of a hair clipper blade assembly according to the present invention; and

FIG. 8 is a drawing showing an example of a DLC coating process according to the present invention.

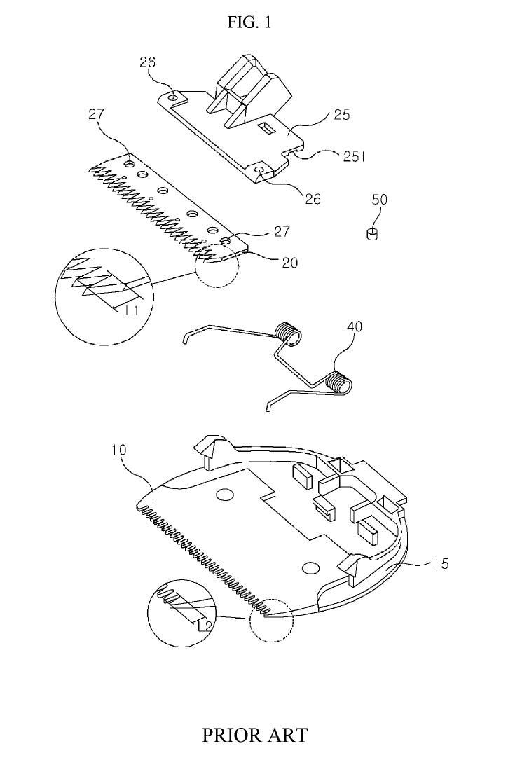

### DETAILED DESCRIPTION OF THE EMBODIMENTS

A description of the various illustrative embodiments of the invention follows.

An embodiment of the present invention provides a hair clipper blade assembly with a depth of the comb teeth of the fixed blade that is twice of that of a fixed blade of a conventional hair clipper to improve the guiding or holding functions of hairs and to make easier the cutting of curly hair as well as straight hair.

An embodiment of the present invention provides a hair clipper blade assembly with improved abrasion resistance and heat resistance by coating a body surface forming a blade with DLC (diamond-like carbon).

An embodiment of the present invention provides a hair clipper blade assembly having an end portion of a hair clipper blade designed in a rounded shape to give a soft contact feeling with the scalp of a user and to prevent the possibility of danger in advance when the end portion contacts hair.

A hair clipper blade assembly according to an embodiment of the present invention to solve one or more of the problems described herein comprises a fixed blade assembled in a front end portion of a fixed blade body fixed by a supporting bracket, a movable blade assembled in and fixed to a front end portion of a movable body, and a coil spring adhering the movable blade to an upper surface of the fixed blade, wherein a comb teeth depth of the fixed blade and the movable blade deeper than a comb teeth depth (L) of a conventional fixed blade and a conventional movable blade, the comb teeth depth having the range of 2.2 mm to 2.8 mm such that the fixed blade and the movable blade have a construction that allows for easy guiding or holding of hair when cutting the hair, so as to maintain fairly good cutting power when, for example, cutting short hair and curly hair.

In an embodiment, the fixed blade and the movable blade have the comb teeth depth of 2L.

In an embodiment, a surface of the fixed blade and the movable blade and a surface of the plate, on which the fixed blade and the movable blade are installed are coated by DLC (Diamond-Like Carbon film).

In another embodiment, the front end portions or the comb teeth of the fixed blade and the movable blade are rounded to have predetermined curvature.

The following describes additional embodiments of a hair clipper blade assembly according to the present invention having a construction for solving one or more of the problems described herein.

An embodiment of a hair clipper according to the present invention provides for easy cutting of curly hair as well as straight hair by including comb teeth of the hair clipper blade, the comb teeth having a depth of approximately twice of that of the comb teeth of a conventional hair clipper blade in order to improve the guiding or holding of hairs.

An embodiment of a hair clipper according to the present invention provides for improved abrasion resistance and heat resistance by coating a body surface forming the hair clipper blade with DLC (diamond-like carbon).

An embodiment of a hair clipper according to the present invention provides an effect to give a soft contact feeling with the scalp of a user and to prevent the possibility of danger in advance when the hair clipper contacts hair by designing an end portion of the hair clipper blade in a rounded shape.

The following is a brief description of certain reference numerals in the drawings:

| | |
|---|---|
| 100: hair clipper blade assembly | 200: fixed blade body |
| 210: fixed blade | 300: movable blade body |
| 310: movable blade | 400: guide plate |

Hereinafter, embodiments of the present invention will be described in detail referring to the drawings.

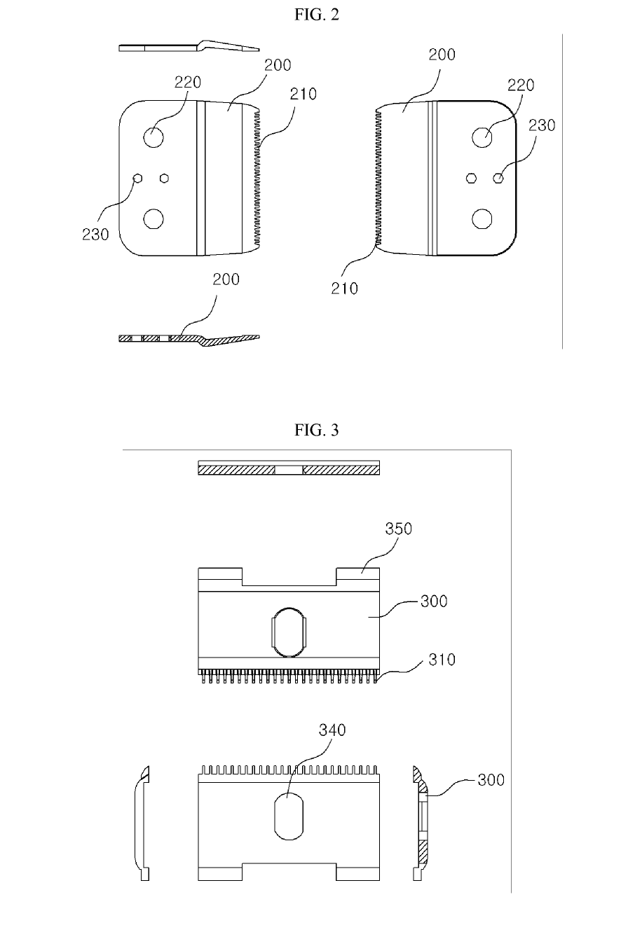

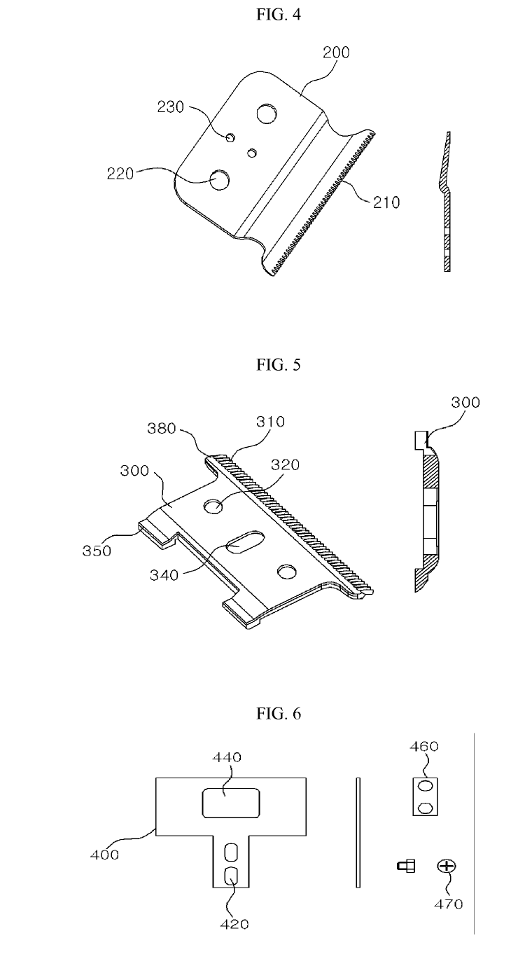

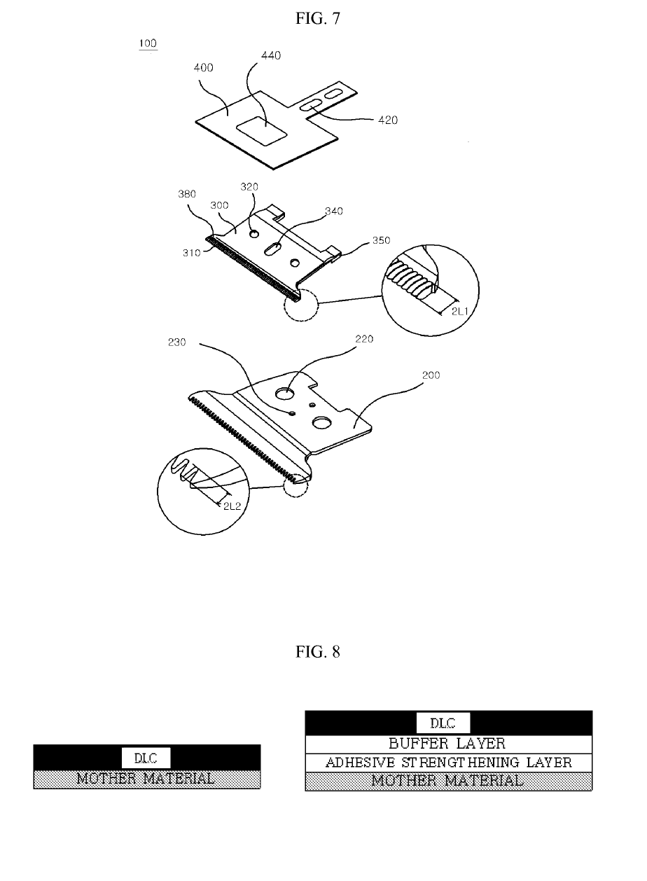

FIG. 2 is a top view, a bottom view, and a lateral view of a fixed blade and a fixed blade body according to a first embodiment of the present invention. FIG. 3 is a top view, a bottom view, and a lateral view of a movable blade and a movable blade body according to a first embodiment of the present invention. FIG. 4 is a perspective view of a fixed blade and a fixed blade body according to a second embodiment of the present invention. FIG. 5 is a perspective view of a movable blade and a movable blade body according to a second embodiment of the present invention. FIG. 7 is a perspective view of a hair clipper blade assembly according to an embodiment of the present invention. FIG. 8 is a drawing showing an example of a DLC coating process according to an embodiment of the present invention.

First, referring to FIG. 7, a detailed construction of a hair clipper blade assembly 100 according to an embodiment of the present invention is described below. The construction of the assembly 100 is largely divided into a fixed blade body 200, a movable blade body 300, a guide plate 400, and a coil spring (not shown). The fixed blade body 200, the movable blade body 300, the guide plate 400, and the coil spring are assembled in a longitudinal direction by assembly members such as a bolt and a coupling shape described later and are fixed in the total hair clipper body and a supporting bracket (not shown).

Next, each portion forming the assembly 100 will be described in detail.

First, referring to FIGS. 2 and 4, the fixed blade body 200, on which the fixed blade 210 is formed will be described. The fixed blade 210 includes comb teeth formed on a front end of the body 200. The comb teeth have a predetermined depth. Body fix bolt holes 220 for fixing a body of a hair clipper fixed blade 210 are formed on a lower end of the body 200, and bolt holes 230 for fixing the guide plate are formed on the middle portion of the lower end.

In an embodiment of the present invention, as shown, the depth of the comb teeth of the fixed blade 210 is deeper than that of a fixed blade of a conventional hair clipper. The deeper depth of the fixed blade 210 provides for improved guiding or holding of hairs and easier cutting of hair. In addition, the cutting of curly hair as well as straight hair is easier when compared to a conventional hair clipper. In addition, this embodiment provides improved cutting power over a conventional hair clipper when cutting hair short.

If the comb teeth depth of the fixed blade of a conventional hair clipper is assumed to be L₂, it is preferable that the comb teeth depth of the fixed blade 210 according to an embodiment of the present invention be 2L₂. That is, the comb teeth depth of the fixed blade according to an embodiment of the present invention is twice than that of the fixed blade of a conventional hair clipper. In another embodiment, it is preferable that the comb teeth depth of the fixed blade have the range of 2.2 mm to 2.8 mm.

In an embodiment, by designing the front end portion as a rounded shape with predetermined curvature, it is preferable that the contact feeling with the scalp of a user is softer when cutting hair and the possibility of danger is prevented in advance, when an end portion of the fixed blade 210 contacts the hair.

Consequently, referring to FIGS. 3 and 5, the movable body 300, on which the movable blade 310 formed will be described. The movable blade 310 is installed on an upper surface of a guide portion 380 in a front end portion of the movable body 300. The movable blade 310 has a blade shape and is capable of moving in left and right and horizontal directions. Body fix bolt holes 320 are formed in left and right portions of the middle portion of the movable body 300. A hole 340 is formed in the middle portion of the movable body 300. The hole 340 has an elliptical shape to overlap a front end groove 440 of the guide plate 400. Assembly supports 350 for coupling with the hair clipper body are formed in the left and right end portions of the lower end of the movable body 300, respectively. Each assembly support 350 has a predetermined height and an extended length.

In an embodiment, the horizontal widths of the front end portion of the fixed blade body 200, on which the fixed blade 210 is fixed, and the front end portion of the movable blade body 300, on which the movable blade 310 is fixed, may be equal or similar to horizontal widths of the lower end portion and the middle portion, as shown in FIG. 3. Alternatively, the right and left portions of the front end portions of the fixed blade body 200 and the movable blade body 300 may be extended in a horizontal direction to enlarge horizontal widths of the front end portions of the fixed blade body 200 and the movable blade body 300, as shown in FIG. 5.

If the comb teeth depth of the movable blade of a conventional hair clipper is assumed to be L₁, it is preferable that the comb teeth depth of the movable blade 310 according to an embodiment of the present invention be 2L₁. That is, the comb teeth depth of the movable blade according to an embodiment of the present invention is twice than that of the movable blade of a conventional hair clipper. In another embodiment, it is preferable that the comb teeth depth of the fixed blade have the range of 2.2 mm to 2.8 mm.

The movable blade 310 is adhered toward the front portion of the fixed blade 210 and is capable of sliding on the front portion of the fixed blade 210 by the coil spring. In this case, an end of the coil spring is connected with the supporting bracket (not shown) forming the hair clipper and another end of the coil spring is connected with a portion of the movable blade body 300 and the guide plate operating along with the portion. Thus, the horizontal and left/right movements of the movable blade 310 are possible. That is, the movable blade 310 performs the horizontal and left/right movements through an eccentric cam by motor rotation, and the coil spring functions as an intermediation for or facilitates the movements.

As shown in the embodiment of FIG. 6, the guide plate 400 has a T-shaped plate structure. The guide plate 400 includes the groove 440 formed on an upper end of the guide plate 400 and a fixed bolt hole 420 formed on a lower end of the guide plate 400, into which a fixed bolt 470 is inserted. The groove 440 has a rounded and squared shape and overlapping a center groove 340 of the movable body 300. The fixed bolt hole 420 is connected and adhered to the fixed plate 460. Thereby, the guide plate 400 is fixed to the movable body 300 and the fixed blade body 200 and operates along with the movable body 300 to function as an intermediation for a horizontal movement of the movable blade 310.

In an embodiment, the assembly processes of the fixed blade body 200, the movable blade body 300, and the guide plate 400 will be described with reference to FIG. 7, which shows a perspective view. First, the movable body 300 having the moveable blade 310 formed thereon is overlapped the upper end of the fixed blade body 200, on which the fixed blade 210 is formed, and thereby a lower surface of the movable blade 310 is adhered on an upper surface of the fixed blade 210 to be coupled to each other.

Next, after the guide plate 400 is overlapped the upper surfaces of the middle portions of the fixed blade body 200 and the movable blade body 300, the fixed blade body 200, the movable blade body 300, an the guide plate 400 are assembled as one body by inserting the bolts 470 into a guide plate bolt hole 420 and screwing. In this time, it is preferable to more improve unifying force by overlapping the fixed plate 460 having holes corresponding to the bolt holes 420 and the lower end of the guide plate 400, and inserting the fix bolts 470 into the bolt holes 420. Thus, the fixed blade body 200, the moveable body 300, the coil spring, and the guide plate 400 are assembled in the longitudinal direction to manufacture the hair clipper blade assembly 100 according to an embodiment of the present invention. In this case, as shown in the embodiment of FIG. 7, the comb teeth depth of the fixed and movable blades according to an embodiment of the present invention is twice of those of a conventional hair clipper.

An operation of the hair clipper blade in the hair clipper assembly 100 according to an embodiment is described below. The movable blade 310 is adhered to the upper surface of the fixed blade 210 by the coil spring to be capable of sliding on the fixed blade 210. The movable blade 310 is fixed to the front end portion of the movable body 300. The movable body 300 moves in left and right directions through a rotation movement of a motor and an eccentric cam not shown, to perform a horizontal movement and cut the hair. At this time, in the horizontal movement of the movable blade 310, since a shape of the guide plate 400 limits a movement range of the movable blade 310 within a predetermined horizontal direction range, cutting hair becomes easier as compared to cutting hair with a conventional hair clipper.

In an embodiment of the present invention, the surfaces of the fixed and movable blades and the surface of the plate on which the fixed and movable blades are fixed are coated by DLC (Diamond-Like Carbon film) to improve abrasion resistance and heat resistance. This minimizes heat occurrence when the hair clipper of such embodiment vibrates with high speed, thereby improving the experience of the person whose hair is being cut.

DLC is generally an amorphous material and has a structure mixed with sp1, sp2, and sp3 hybrid orbitals. Since the properties of a DLC of hardness, corrosion resistance, and abrasion resistance are similar to those of a diamond, the DLC is called “Diamond-like Carbon”. The DLC is also referred to as a DFC, and the DFC is sometimes considered to be the abbreviated form of “Diamond like Carbon”. The DFC is a plasma coating based on carbon like the DLC.

The DLC coating generally has properties of good hardness, abrasion resistance, electric insulation, high light transmission, and reflection. Since the chemical stability of a surface coated with DLC is fairly good, the DLC coating provides fairly strong protection against corrosion and has fairly good adhesion resistance with another metal. Also, since the properties of the DLC coating have the low coefficient of friction less than 0.1 nearly similar to MoS₂ that is a solid lubrication film, abrasion between a film of the DLC coating and another material is largely decreased, as compared to other hard thin film.

The coating working processes are performed through sequential processes of order of stock-in, import inspection, pre-treatment process, holding process, gauging process, coating process, production inspection, packing process, and stock-out. Foreign matters and oil-residuum on the surface of a product are removed in the pre-treatment process, and preferably, in the gauging process, gauging equipments adaptive to a product shape are used. A processing time of about 1 minute and 30 seconds to 2 minutes and 30 seconds is required for the coating process.

Next, referring to FIG. 8, an example of a coating method will be described. As shown, in DLC coating, there is a coating method with an adhesive layer and a coating method without the adhesive layer. In the coating method with the adhesive layer, after an adhesive strengthening layer and a buffer layer on an upper surface of a mother material are formed, the DLC surface treatment is performed. Otherwise, in the coating method without the adhesive layer, the DLC surface treatment is directly performed on the upper surface of the mother material.

After the hair clipper blade assembly is assembled through the construction and the assembly processes, the hair clipper blade assembly is combined with the total hair clipper body, including the supporting bracket, to prepare it for use in cutting hair.

While this invention has been particularly shown and described with reference to exemplary embodiments thereof, it will be understood by those skilled in the art that various changes in form and details may be made therein without departing from the spirit and scope of the invention as defined by the claims.

The present invention relates to a hair clipper assembly. Currently, hair cutting processes using scissors are being rapidly replaced with processes using an electric hair appliance having a hair clipper blade. Also, electric hair appliances are being increasingly used in homes due to convenience. Since various embodiments of the present invention improves the comb teeth depth and the blade shape, the usefulness and industrial availability of the hair clipper assembly according to those embodiments is also increased.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein.

What is claimed is:

1. A hair clipper blade assembly comprising:
a fixed blade body having a front end portion and a back end portion, the front end portion of the fixed blade body having a fixed blade with a plurality of comb teeth;
a movable blade body having a front end portion and a back end portion, the front end portion of the movable blade body having a movable blade with a plurality of comb teeth; and
a guide plate attached to the fixed blade body and the movable blade body, the guide plate facilitating movement of the movable blade,
wherein a diamond-like carbon film is formed over a surface of the guide plate.

2. The hair clipper blade assembly of claim 1, wherein the plurality of comb teeth of the fixed blade have a depth in the range of 2.2 mm to 2.8 mm.

3. The hair clipper blade assembly of claim 1, wherein the plurality of comb teeth of the movable blade have a depth in the range of 2.2 mm to 2.8 mm.

4. The hair clipper blade assembly of claim 1, wherein a diamond-like carbon film is formed over a surface of the fixed blade body.

5. The hair clipper blade assembly of claim 1, wherein a diamond-like carbon film is formed over a surface of the movable blade body.

6. The hair clipper blade assembly of claim 1, wherein at least one of the plurality of comb teeth of the fixed blade is rounded.

7. The hair clipper blade assembly of claim 1, wherein at least one of the plurality of comb teeth of the movable blade is rounded.

8. The hair clipper blade assembly of claim 1, wherein the front end portion of the fixed blade body is wider than the back end portion of the fixed blade body.

9. The hair clipper blade assembly of claim 1, wherein the front end portion of the movable blade body is wider than the back end portion of the movable blade body.
